(19) United States
(12) Patent Application Publication
(10) Pub. No.: US 2015/0323346 A1
(43) Pub. Date: Nov. 12, 2015

(54) Magnetic Measuring Arrangement and Corresponding Sensor Arrangement for Detecting Motion of a Moving Component

(71) Applicant: ROBERT BOSCH GMBH, Stuttgart (DE)

(72) Inventors: Eduard Maiterth, Heilbronn (DE); Markus Kienzle, Lehrensteinsfeld (DE); Mathias Kimmerle, Steinheim (DE); Klaus Walter, Bietigheim-Bissingen (DE); Joerg Siedentopf, Untergruppenbach (DE)

(21) Appl. No.: 14/441,089

(22) PCT Filed: Oct. 31, 2013
(86) PCT No.: PCT/EP2013/072820

§ 371 Date: May 6, 2015

(30) Foreign Application Priority Data
Nov. 6, 2012 (DE) 10 2012 220 139.4

(51) Int. Cl. G01D 5/14

(52) U.S. Cl. CPC G01D 5/14

(57) ABSTRACT

Movement of an object causes a change in at least one magnetic variable. A magnetic measuring arrangement configured to detect motion of the object includes at least one permanent magnet and at least one sensor element configured to detect the magnetic variable. The permanent magnet and sensor element are configured and arranged at a distance from each other so as to be relatively movable. The change in the magnetic variable detected by the sensor element can be evaluated to determine at least one of an angle of rotation and a position of the object. A sensor arrangement includes such a magnetic measuring arrangement and at least one shield element formed from a magnetically conductive material and configured and arranged such that the shield element encloses at least one of the permanent magnet and the sensor element, at least in part.

### PRIOR ART

The invention is based on a magnetic measuring arrangement for sensing motion of a moving component, according to the type of the independent claim 1, and on a sensor arrangement for sensing motion of a moving component, according to the type of the independent claim 6.

DE 10 2009 055 104 A1 describes a magnetic field sensor arrangement for path sensing on translationally moving components. In the case of the described magnetic field sensor arrangement, spatial components of the magnetic field of a magnet system on the moving component change in their direction over the path to be sensed, such that their position in relation to a stationary sensor can be detected accordingly. On the linear component, which can be moved in one further degree of freedom, there is at least one magnet as a constituent part of the magnet system, assigned to which, at a predefined distance, there is at least one stationary sensor, located opposite, that is sensitive to magnetic fields.

DE 10 2007 024 867 A1 describes a measuring means for contactlessly sensing a rotation angle. The described measuring means comprises a first body, on which a magnet is disposed at a radial distance in relation to a rotation axis, and a second body having an element that is sensitive to magnetic fields, for generating a measurement signal. In this case, upon a relative motion between the first and the second body, the element that is sensitive to magnetic fields and the magnet are disposed tangentially in respect of a circular path of the relative motion, the magnet being magnetized or polarized radially in a plane that, in relation to the radial direction, is disposed perpendicularly in relation to the rotation axis.

DE 10 2008 020 153 A1 describes an angle sensing device. The described device comprises a rotation element having at least one magnetic north pole region and at least one magnetic south pole region that are disposed alternately around a rotation centre, a magnetic-field sensing portion having a magnetic plate and sensing elements, which sense magnitudes of magnetic components in a direction perpendicular to the magnetic plate, and a computing unit, which determines a rotation angle. The magnetic-field sensing portion is disposed such that the magnetic plate is aligned perpendicularly in relation to a first direction in which the magnetic field strength is maximal, the magnetic-field sensing portion sensing the magnitudes of the magnetic components in the first direction, and in a second direction that corresponds to a direction in which the magnetic north and south pole regions are disposed circumferentially.

### DISCLOSURE OF THE INVENTION

By contrast, the magnetic measuring arrangement, according to the invention, for sensing motion of a moving component, having the features of the independent claims 1, and the sensor arrangement, according to the invention, for sensing motion of a moving component, having the features of the independent claim 6, have the advantage that the influences of stray magnetic fields are minimized by means of a shielding element.

Embodiments of the present invention advantageously enable the shielding element to be easily integrated into an existing design, such that no additional structural volume is required.

The core of the invention consists in the use of a shielding element made of a ferromagnetic or magnetically conductive material. The shielding element is disposed such that it at least partially surrounds the at least one sensor element that senses a magnetic field and/or the at least one magnet that generates the magnetic field. Thus, for example, a shielding element that surrounds both the at least one sensor element and the at least one magnet may be provided. Alternatively, a shielding element that surrounds the at least one sensor element or the at least one magnet may be provided. Furthermore, two shielding elements may be provided, wherein a first shielding element surrounds the at least one sensor element and a second shielding element surrounds the at least one magnet. As a result, the generation of the magnetic field by the at least one magnet and/or the sensing of the generated magnetic field by the at least one sensor element can be protected against external magnetic field influences, and the measuring accuracy can be increased. Embodiments of the present invention may be used both to sense a rotation angle of rotationally movable components and to sense a position of translationally moving components.

Embodiments of the present invention provide a magnetic measuring arrangement, for sensing motion of a moving component, that comprises at least one permanent magnet and at least one sensor element for sensing at least one magnetic quantity. The at least one permanent magnet and the at least one sensor element are disposed such that they are movable relative to and at a distance from each other, wherein a motion of the moving component causes an alteration of the sensed at least one magnetic quantity that can be evaluated for the purpose of determining a rotation angle and/or a position of the moving component. According to the invention, at least one shielding element is provided, which is made of a magnetically conductive material and disposed such that it at least partially surrounds the at least one permanent magnet and/or the at least one sensor element. For the purpose of changing the sensed at least one magnetic quantity, the at least one sensor or the at least one magnet may be connected to the movable component.

The magnetic measuring arrangement according to the invention is preferably used in a sensor arrangement for sensing motion of a moving component that comprises a measured-value transmitter and a measured-value pickup.

The measures and developments stated in the dependent claims render possible advantageous improvements of the magnetic measuring arrangement, specified in the independent claim 1, for sensing motion of a moving component, and of the sensor arrangement, specified in the independent claim 6, for sensing motion of a moving component.

In an advantageous design of the magnetic measuring arrangement according to the invention, the at least one shielding element may be realized, for example, as a frame or hoop or hollow body having a round or angular cross section. The at least one shielding element, realized as a frame, may be realized in a closed manner or with a gap. The frame may be closed, for example, by stamping or welding. The gap may have, for example, a straight or stepped or oblique or zigzag contour. The contour of the gap in this case is preferably selected such that the frames cannot become caught in each other during transport. The at least one shielding element may also be realized in any other geometry, in order to adapt to the structural design aspects of the sensor design. The at least one shielding element may thus be realized, for example, as a pot or cap.

In an advantageous design of the sensor arrangement according to the invention, the measured-value pickup may have a first housing, in which the at least one sensor element is disposed. The measured-value transmitter may have a second housing, in which the at least one permanent magnet is disposed. The first housing may be connected to the second housing via connecting elements that are realized, for example, as hollow rivets.

In a further advantageous design of the sensor arrangement according to the invention, the at least one shielding element may be integrated into the first housing and/or the second housing, or at least partially surround the first housing and/or the second housing. The at least one shielding element may be matched to the first housing and/or the second housing, and have at least one recess and/or varying dimensions. The at least one shielding element may have recesses and vary in its height and/or its thickness, to enable it to be matched to the housing of the measured-value transmitter and/or to the housing of the measured-value pickup. Furthermore, the at least one shielding element may be realized as a shielding cap that partially or completely surrounds the first and/or the second housing, or be realized as a shielding pot that is integrated into the first and/or the second housing.

In a further advantageous design of the sensor arrangement according to the invention, the housing may have a recess in which the at least one shielding element is inserted. In this case, the at least one shielding element may preferably be realized as a slotted frame having a greater external diameter than the recess, and be inserted under tension in the recess.

In a further advantageous design of the sensor arrangement according to the invention, the movable component may correspond to a pedal or a steering column.

Exemplary embodiments of the invention are represented in the drawings and explained more fully in the description that follows. In the drawings, components or elements that perform the same or similar functions are denoted by the same references.

### BRIEF DESCRIPTION OF THE DRAWINGS

FIG. 1 shows a schematic sectional representation of a first exemplary embodiment of a magnetic measuring arrangement, according to the invention, for sensing motion of a moving component.

FIG. 2 shows a schematic sectional representation of a second exemplary embodiment of a magnetic measuring arrangement, according to the invention, for sensing motion of a moving component.

FIG. 3 shows a schematic sectional representation of a third exemplary embodiment of a magnetic measuring arrangement, according to the invention, for sensing motion of a moving component.

FIG. 4 shows a schematic sectional representation of a fourth exemplary embodiment of a magnetic measuring arrangement, according to the invention, for sensing motion of a moving component.

FIG. 5 shows a schematic sectional representation of a fifth exemplary embodiment of a magnetic measuring arrangement, according to the invention, for sensing motion of a moving component.

FIG. 6 shows a schematic sectional representation of a sixth exemplary embodiment of a magnetic measuring arrangement, according to the invention, for sensing motion of a moving component.

FIG. 7 shows a schematic perspective representation of a first exemplary embodiment of a shielding element for a magnetic measuring arrangement, according to the invention, for sensing motion of a moving component.

FIG. 8 shows a schematic perspective representation of a second exemplary embodiment of a shielding element for a magnetic measuring arrangement, according to the invention, for sensing motion of a moving component.

FIG. 9 shows a schematic perspective representation of a third exemplary embodiment of a shielding element for a magnetic measuring arrangement, according to the invention, for sensing motion of a moving component.

FIG. 10 shows a schematic perspective representation of a fourth exemplary embodiment of a shielding element for a magnetic measuring arrangement, according to the invention, for sensing motion of a moving component.

FIG. 11 shows a schematic perspective representation of a fifth exemplary embodiment of a shielding element for a magnetic measuring arrangement, according to the invention, for sensing motion of a moving component.

FIG. 12 shows a schematic perspective representation of a first exemplary embodiment of a sensor arrangement, according to the invention, for sensing motion of a moving component, in a pre-assembly state.

FIG. 13 shows a schematic perspective representation of the first exemplary embodiment of a sensor arrangement, according to the invention, for sensing motion of a moving component, in a partially assembled state.

FIG. 14 shows a schematic perspective representation of the first exemplary embodiment of a sensor arrangement, according to the invention, for sensing motion of a moving component, in an assembled state.

FIG. 15 shows a schematic perspective representation of a second exemplary embodiment of a sensor arrangement, according to the invention, for sensing motion of a moving component, in an assembled state.

FIG. 16 shows a schematic perspective representation of the third exemplary embodiment of a sensor arrangement, according to the invention, for sensing motion of a moving component, in an assembled state.

### EMBODIMENTS OF THE INVENTION

It is known from the prior art, for the purpose of sensing angles of a rotating shaft, to sense the rotary motion of magnet centrally on the shaft. For this purpose, the rotation of the magnetic vector about the rotation axis is sensed by means of correspondingly sensitive magnet sensors such as, for example, AMR and/or GMR sensors, Hall sensors, Hall sensors having integrated magnetic-field concentrators, etc. What is of importance for the sensor element used is the sensing of the rotating magnetic vector. In the case of a magnet realized, for example, as a round magnet that rotates in front of the sensor element, the magnetic vector also rotates. This rotary motion is sensed by a sensor element, located in front of it, which is part of an ASIC (application-specific integrated circuit) and which detects the magnetic vector that is parallel to the surface of the magnet. In the case of a two-dimensional or three-dimensional Hall sensor, this is effected by indirect angle sensing by means of an arctangent function of the directional magnetic flux densities. Such a Hall sensor can unambiguously detect the angular position of the round magnet over 360°. AMR sensors render possible direct angle sensing, and because of their design they sense the angle of the magnetic vector directly. Devices for angle or path sensing may be used in vehicles, in various actuating means for vehicle braking systems, for headlamp beam adjustment, for sensing an angular position of shafts, but also, in particular, for sensing a driver's braking intention on the brake pedal, or sensing a driver's acceleration intention on the accelerator pedal. The magnetic flux density may be affected by the action of stray magnetic fields that occur, for example, because of conductors carrying current, such that there may be a signal deviation.

For the purpose of sensing the position of a translationally moving slide, the translational motion of at least one magnet coupled to the slide can be sensed. For this purpose, the rotation of the magnetic vector along the at least one magnet can be sensed by means of correspondingly sensitive magnet sensors that are realized, for example, as AMR and/or GMR sensors, Hall sensors, Hall sensors having integrated magnetic-field concentrators, or other 2D- or 3D-Hall sensors or AMR sensors. What is of importance for the sensor element is the sensing of the rotating magnetic vector. Thus, for example, a translationally moving bar magnet may be used. With the displacement of the bar magnet, the orientation of the magnetic field vectors changes in respect of a fixed point. This change in orientation of the magnetic field vectors can be sensed by the at least one sensor element, and evaluated. In the case of a 2D- or 3D-Hall sensor element, this is effected by formation of an arctangent of the magnetic flux density, or indirect angle sensing by means of inplanar magnetic field components. Such a Hall sensor can unambiguously detect the angular position of the round magnet over 360.

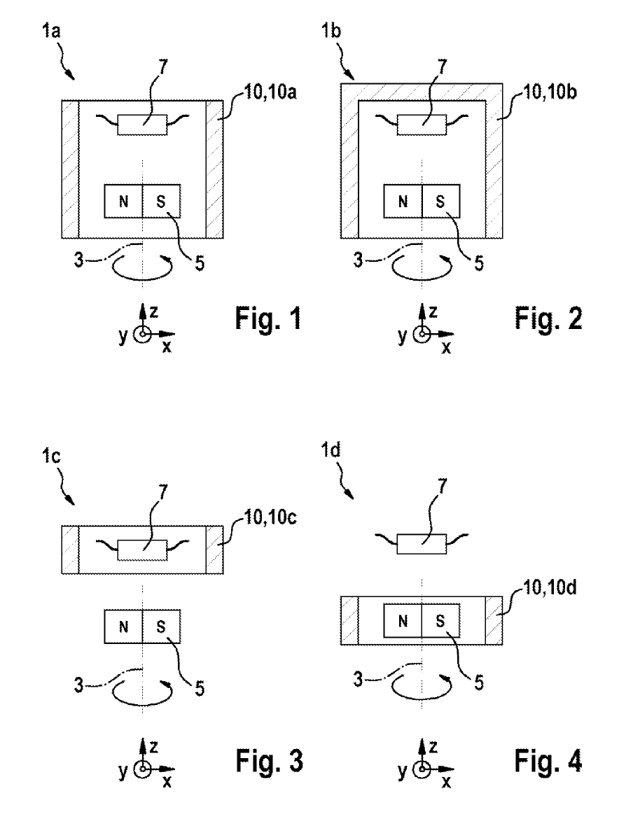

As is shown by FIGS. 1 to 6, the represented exemplary embodiments of a magnetic measuring arrangement 1a, 1b, 1c, 1d, 20a, 20b, according to the invention, for sensing motion of a moving component comprise at least one permanent magnet 5, 25 having a magnetic north pole N and a magnetic south pole S, and at least one sensor element 7, 27 for sensing at least one magnetic quantity. The at least one permanent magnet 5, 25 and the at least one sensor element 7, 27 are disposed such that they are movable relative to and at a distance from each other, wherein a motion of the moving component causes an alteration of the sensed at least one magnetic quantity that can be evaluated for the purpose of determining a rotation angle and/or a position of the moving component. According to the invention, at least one shielding element 10, 10a, 10b, 10c, 10d, 10e, 10f, 10g is provided, which is made of a magnetically conductive material and disposed such that it at least partially surrounds the at least one permanent magnet 5, 25 and/or the at least one sensor element 7, 27.

As is further shown by FIGS. 1 to 6, the at least one shielding element 10, 10a, 10b, 10c, 10d, 10e, 10f, 10g is disposed such that a vertical axis, or longitudinal axis, of the at least one shielding element 10, 10a, 10b, 10c, 10d, 10e, 10f, 10g is preferably perpendicular to a sensitive plane that is spanned, for example, from a flux density Bₓ, along an x direction, and from a flux density B_{y}, along a y direction.

In the case of the exemplary embodiments represented in FIGS. 1 to 4, the magnetic measuring arrangement 1a, 1b, 1c, 1d according to the invention is used for sensing a rotation angle of a component, not shown, that can move rotationally about a rotation axis 3, and to which the at least one permanent magnet 5 is coupled. In the case of an alternative exemplary embodiment, which is not represented, the sensor element 7 is connected to the rotationally moving component that is not shown, and the at least one permanent magnet 5 is disposed in a stationary manner.

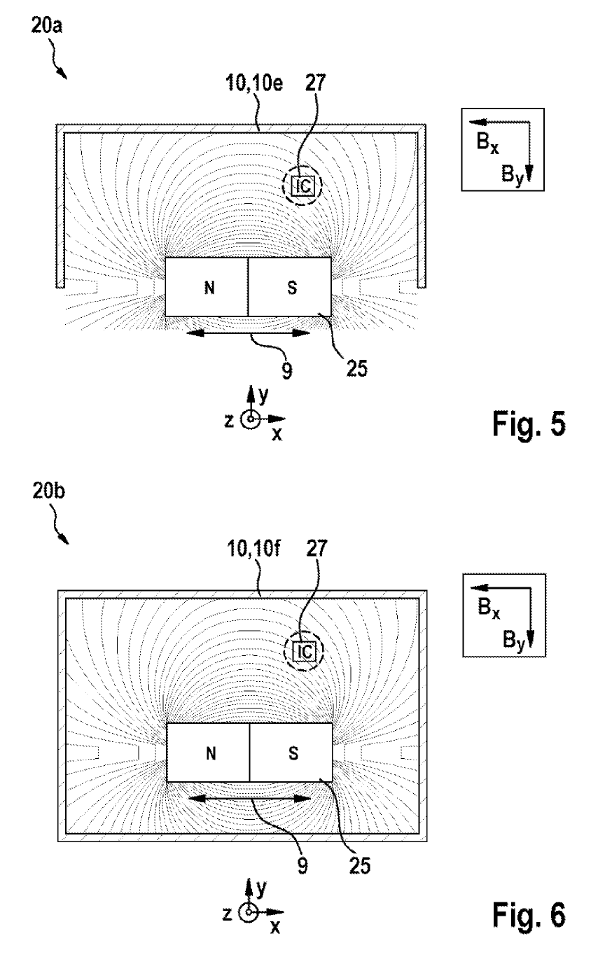

In the case of the exemplary embodiments represented in FIGS. 5 and 6, the magnetic measuring arrangement 20a, 20b according to the invention is used for sensing a position of a component, not shown, that moves translationally along a motion direction 9, and to which the at least one permanent magnet 25 is coupled. In the case of an alternative exemplary embodiment, which is not represented, the sensor element 27 is connected to the translationally moving component that is not shown, and the at least one permanent magnet 25 is disposed in a stationary manner.

As is further shown by FIG. 1, in the represented first exemplary embodiment the shielding element 10 is realized as a frame 10a, or hollow body, that is open at the top and bottom and has a round or angular cross section, that surrounds both the sensor element 7 and the permanent magnet 5.

As is further shown by FIG. 2, in the represented second exemplary embodiment the shielding element 10 is realized as a pot 10b, or hollow body, that is open at the bottom and has a round or angular cross section, and that surrounds both the sensor element 7 and the permanent magnet 5.

As is further shown by FIG. 3, in the represented third exemplary embodiment the shielding element 10 is realized as a frame 10c that is open at the top and bottom and has a round or angular cross section, and that surrounds only the sensor element 7.

As is further shown by FIG. 4, in the represented fourth exemplary embodiment the shielding element 10 is realized as a frame 10d that is open at the top and bottom and has a round or angular cross section, and that surrounds only the permanent magnet 5.

As is further shown by FIG. 5, in the represented fifth exemplary embodiment the shielding element 10 is realized as a pot 10e, or hoop, that is open at the bottom and has an angular cross section, and that surrounds the sensor element 27 completely and surrounds the permanent magnet 25 partially.

As is further shown by FIG. 6, in the represented fifth exemplary embodiment the shielding element 10 is realized as a ring, or hollow body, that is open at the front and back and has an angular cross section, and that surrounds the sensor element 27 and the permanent magnet 25.

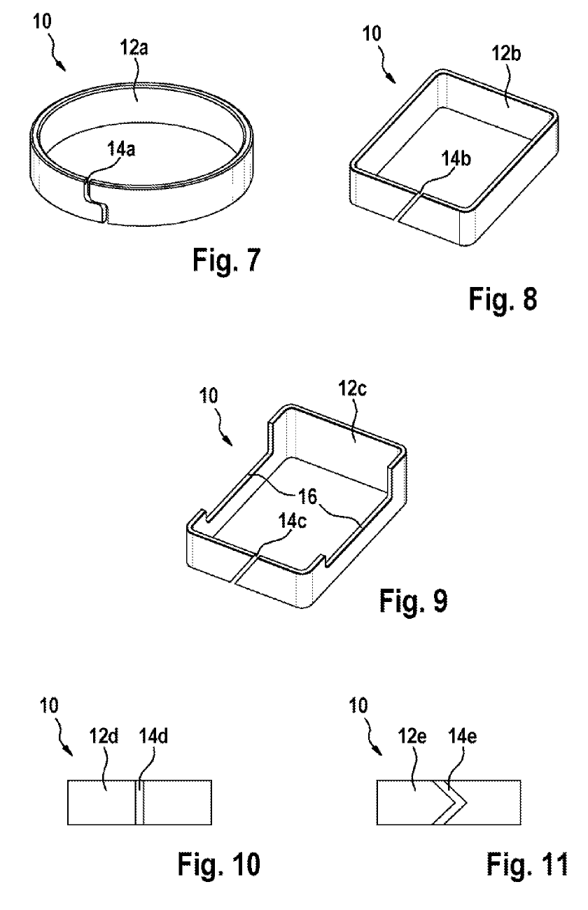

As is shown by FIGS. 7 to 11, in the represented exemplary embodiments the shielding elements 10 realized as frames each comprise a main body 12a, 12b, 12c, 12d, 12e having a gap 14a, 14b, 14c, 14d, 14e.

As is further shown by FIG. 7, the main body 12a of the represented shielding element 10 has a round cross section and a gap 14a having a stepped contour.

As is further shown by FIG. 8, the main body 12b of the represented shielding element 10 has an angular cross section and a gap 14b having an oblique contour.

As is further shown by FIG. 9, the main body 12c of the represented shielding element 10 has an angular cross section and a gap 14c having an oblique contour. In addition, two sides of the main body 12c are of differing heights, and there are recesses 16 made in two further sides of the main body 12c.

As is further shown by FIG. 10, the main body 12d of the represented shielding element 10 has an angular or round cross section and a gap 14d having a straight contour.

As is further shown by FIG. 11, the main body 12e of the represented shielding element 10 has an angular or round cross section and a gap 14e having a zigzag contour.

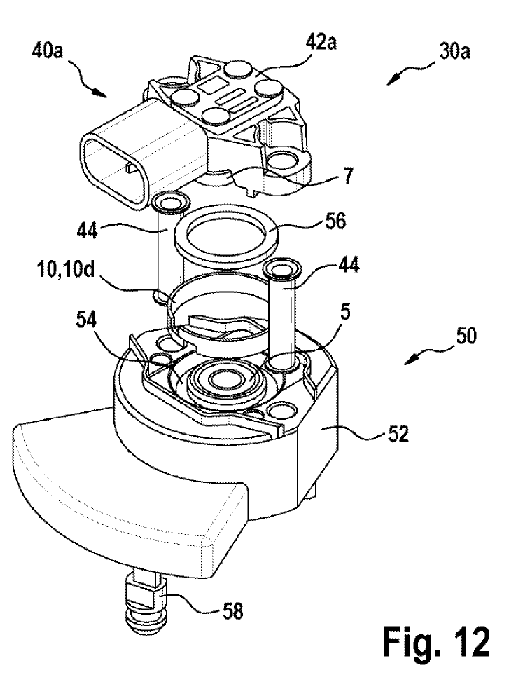

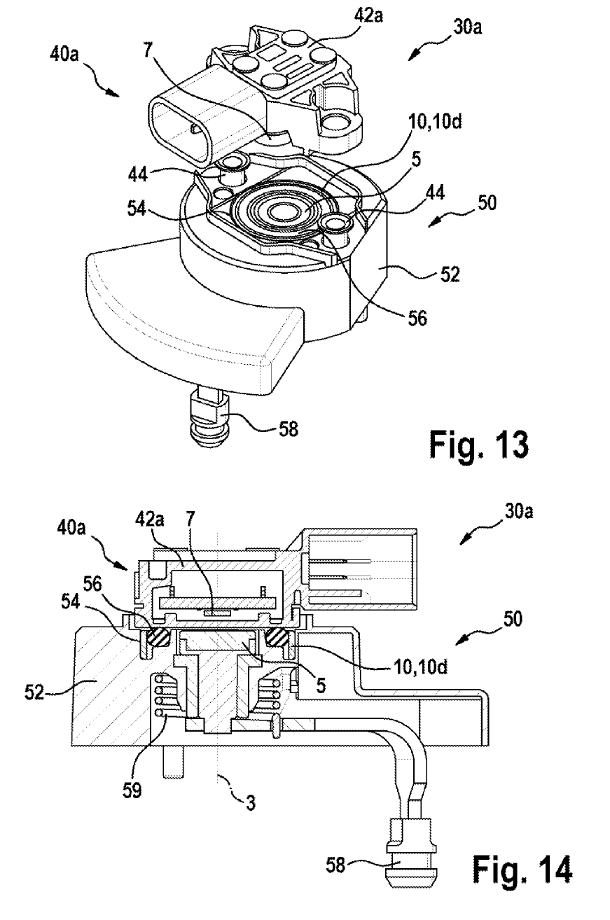

As is shown by FIGS. 12 to 16, the represented exemplary embodiments of a sensor arrangement 30a, 30b, 30c, according to the invention, for sensing motion of a moving component 58 each have a measured-value transmitter 50 and a measured-value pickup 40a, 40b, 40c. As is further shown by FIGS. 12 to 16, the measured-value pickup 40a, 40b, 40c has a first housing 42a, 42b, 42c, in which the at least one sensor element 7 is disposed. The measured-value transmitter 50 has a second housing 52, in which the at least one permanent magnet 5 is disposed. In addition, the first housing 42a, 42b, 42c is connected to the second housing 52 by means of connecting elements 44 that are realized, for example, as hollow rivets. For the purpose of fastening the sensor arrangement 30a, 30b, 30c in the vehicle, screws may be passed through the hollow rivets and screwed tight in corresponding receivers.

As is further shown by FIGS. 12 to 16, the represented exemplary embodiments of the sensor arrangement 30a, 30b, 30c according to the invention are used to determine a rotary motion of an actuating lever 58 that is coupled to a pedal, not represented, in order to sense a driver's intention on the brake pedal or accelerator pedal. As is further shown by FIGS. 12 to 16, the measured-value transmitter 50 is of identical design in the represented exemplary embodiments. In this case, a shaft connected to the at least one permanent magnet 5 is rotated, via the actuating lever 5, against the force of a restoring spring 59, by the pedal, which is not represented. Located above the permanent magnet 5, at a defined distance that represents a magnetic air gap, is the at least one sensor element 7, which is preferably realized as an ASIC (application-specific integrated circuit). The at least one sensor element 7 senses at least one magnetic quantity, which changes as a result of the rotary motion of the at least one permanent magnet 5. As a result, the at least one sensor element 7 can deliver to a subsequent evaluation circuit of the ASIC a signal that can be converted into the absolute rotation angle to which the actuating lever 5 is subjected.

As is further shown by FIGS. 12 to 16, the housing 52 of the measured-value transmitter 50 has a recess 54, in which a shielding element 10, 10d realized as a slotted frame 10d having a round cross section, is inserted. Advantageously, the shielding element 10, 10d is realized with a greater external diameter than the recess 54, and is inserted and positioned under tension in the recess 54. In addition, a seal 56, which bears against the inside of the shielding element 10, 10d, is disposed in the recess 54.

As is further shown by FIGS. 12 to 14, the represented first exemplary embodiment of the sensor arrangement 30a according to the invention has only one shielding element 10, 10d, which is disposed in the second housing 52 of the measured-value transmitter 50 such that it surrounds the at least one permanent magnet 5.

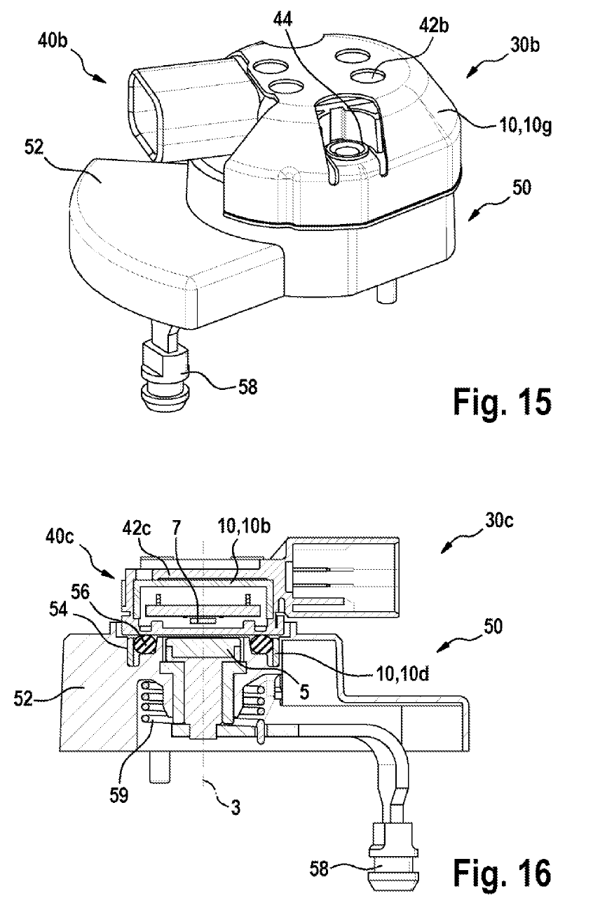

As is further shown by FIG. 15, the represented second exemplary embodiment of the sensor arrangement 30b according to the invention, in addition to having the shielding element 10, 10d disposed in the second housing 52 of the measured-value transmitter 50, has a further shielding element 10, realized as a cap 10g, which partially surrounds the first housing 42b of the measured-value pickup 40b and, consequently, the at least one sensor element 7.

As is further shown by FIG. 16, the represented third exemplary embodiment of the sensor arrangement 30c according to the invention, in addition to having the shielding element 10, 10d disposed in the second housing 52 of the measured-value transmitter 50, has a further shielding element 10, realized as a pot 10b, which is integrated into the first housing 42c of the measured-value pickup 40c and surrounds the at least one sensor element 7.

Owing to the at least one shielding element, embodiments of the present invention make it possible to minimize the influence of external stray magnetic fields, and enable the shielding element to be easily integrated into the existing housing design, such that no additional structural volume is required.

1. A magnetic measuring arrangement for sensing motion of a moving component, comprising;
at least one permanent magnet;
at least one sensor element configured to sense at least one magnetic quantity, wherein:
the at least one permanent magnet and the at least one sensor element are configured and arranged so as to be movable relative to and at a distance from each other, and
a motion of the moving component causes an alteration of the at least one magnetic quantity sensed by the at least one sensor element, the alteration being evaluable to determine at least one of a rotation angle and a position of the moving component; and
at least one shielding element, which is formed from a magnetically conductive material and which is configured and arranged so as to at least partially surrounds at least one of the at least one permanent magnet and the at least one sensor element.

2. The measuring arrangement as claimed in claim 1, wherein the at least one shielding element includes (i) a frame, (ii) a hoop, or (iii) a hollow body, which has a round or angular cross section.

3. The measuring arrangement as claimed in claim 2, wherein:
the at least one shielding element includes the frame; and
said frame is either configured so as to be a closed frame or configured so as to include a gap.

4. The measuring arrangement as claimed in claim 3, wherein the gap is defined by a contour of the frame that is one of straight, stepped, oblique, or zigzag.

5. The measuring arrangement as claimed in claim 1, wherein the at least one shielding element has a shape which defines a pot or a cap.

6. A sensor arrangement for sensing motion of a moving object, comprising;
a measured-value transmitter;
a measured-value pickup; and
a magnetic measuring arrangement that has:
at least one permanent magnet;
at least one sensor element configured to sense at least one magnetic quantity, wherein:
the at least one permanent magnet and the at least one sensor element are configured and arranged so as to be movable relative to and at a distance from each other, and
a motion of the moving component causes an alteration of the at least one magnetic quantity sensed by the at least one sensor element, the alteration being evaluable to determine at least one of a rotation angle and a position of the moving component; and
at least one shielding element, which is formed from a magnetically conductive material and which is configured and arranged so as to at least partially surrounds at least one of the at least one permanent magnet and the at least one sensor element.

7. The sensor arrangement as claimed in claim 6, wherein:
the measured-value pickup includes a first housing; and
the at least one sensor element of the magnetic measuring arrangement is disposed in the first housing.

8. The sensor arrangement as claimed in claim 6, wherein:
the measured-value transmitter includes a second housing; and
the at least one permanent magnet of the magnetic measuring arrangement is disposed in the second housing.

9. The sensor arrangement as claimed in claim 8, wherein:
the measured-value pickup includes a first housing;
the at least one sensor element of the magnetic measuring arrangement is disposed in the first housing; and
the first housing is connected to the second housing via connecting elements.

10. The sensor arrangement as claimed in claim 8, wherein:
the measured-value pickup includes a first housing;
the at least one sensor element of the magnetic measuring arrangement is disposed in the first housing; and
the at least one shielding element is either (i) integral with at least one of the first housing and the second housing, or (ii) configured and arranged so as to at least partially surround at least one of the first housing and the second housing.

11. The sensor arrangement as claimed in claim 8, wherein:
the measured-value pickup includes a first housing;
the at least one sensor element of the magnetic measuring arrangement is disposed in the first housing; and
the at least one shielding element has a shape that is matched to a shape of at least one of the first housing and the second housing, and has at least one of (i) at least one recess, and (ii) at least one dimension that varies along an extent of the at least one shielding element.

12. The sensor arrangement as claimed in claim 8, wherein:
the second housing has a recess; and
the at least one shielding element is inserted in the recess.

13. The sensor arrangement as claimed in claim 12, wherein the at least one shielding element includes a slotted frame which has a greater external diameter than a diameter of the recess, such that the at least one shielding element is inserted under tension in the recess.

14. The sensor arrangement as claimed in claim 6, wherein the movable component is a pedal or a steering column.
